(19) United States
(12) Patent Application Publication
(10) Pub. No.: US 2009/0212030 A1
(43) Pub. Date: Aug. 27, 2009

(54) Autofocus for Ablation Laser

(75) Inventor: George M. Clifford, JR., Los Altos Hills, CA (US)

Correspondence Address: ELIZABETH ANNE NEVIS, 1219 TORRANCE AVE., SUNNYVALE, CA, 94089, US

(73) Assignee: OPTISOLAR, INC., A DELAWARE CORPORATION, Hayward, CA (US)

(21) Appl. No.: 12/036,977

(22) Filed: Feb. 25, 2008

(51) Int. Cl. B23K 26/073

(52) U.S. Cl. 219/121.72; 219/121.73

(57) ABSTRACT

A laser ablation system is controlled by an autofocus subsystem particularly optimized for precision ablation of large workpieces, in an open factory environment where temperatures are not tightly controlled, where the workpieces may have high-spatial-frequency features that affect the focus condition of the working beam. The autofocus operates at a high bandwidth to support high process speed. The autofocus beam shares most of its optical path with the working beam, so its measurements account for thermal effects in the beam train as well as the workpiece. The autofocus beam measures target or adjacent areas just before, or during, ablation, so that temperature drifts do not have time to change the effective focus error. The autofocus spot is substantially the same size as the working spot, so its measurements account for workpiece features of the same spatial frequencies that affect the working beam.

### RELATED APPLICATIONS

None

### FEDERALLY SPONSORED RESEARCH AND DEVELOPMENT

None

### APPENDICES

None

### BACKGROUND OF THE INVENTION

This invention is related to automatic focusing (“autofocus”) devices controlled by photocells, and their use in industrial systems for laser ablation and other types of laser processing with similar requirements of precision. In this document, “ablation” includes any disruptive removal of material from the surface of a workpiece, whether or not thermal effects are involved. The higher the precision and accuracy required of the ablation process, and the more optical path-length tolerances build up between the process tool and the workpiece, the more the process will benefit from an optimally designed autofocus.

Laser ablation is widely used to remove material from workpiece surfaces when the recesses desired are shallow (typically submicron to 250 μm) and the recess depth and width must be tightly controlled (typically ±<10 μm). The object of ablation is to remove material from an intended area (the “target area”) without changing the essential physical or chemical characteristics of adjacent “non-target” material. Therefore, it is desirable for ablation lasers to have operating wavelengths that are strongly absorbed by their intended target materials, so that the ablating light does not substantially penetrate into adjacent non-target material. Ablation lasers generally deliver their energy in short pulses (fs to μs, depending on the laser and target material), to take advantage of the high peak energy deliverable by a short pulse in some laser types, and also because the peak energy quickly subsides before significant heat can diffuse into adjacent non-target regions.

FIG. 1a is a conceptual diagram of top-surface ablation, the most common laser ablation configuration. Laser 101 produces a working beam 102. Beam-steering assembly 103 aims working beam 102 toward a target location on the top surface of workpiece 106. In practice, beam-steering assembly 103 may include prisms, reflectors, and parallel or wedged windows. Beam steering assembly 103 can be static, or it can move to dynamically adjust the position of the beam in the plane of the workpiece. Condenser assembly 104 shapes working beam 102 into a working spot 105 at the top surface of workpiece 106 (i.e., the target layer is the closest layer to the condenser during the ablation operation). In practice, condenser assembly 104 may include lenses, reflectors, apodizers, spatial filters, or beam homogenizers. Whether working spot 105 is a Gaussian or multimode beam waist, an image of an aperture, or a superposition of previously split beam sections, its peak power density (PPD) exceeds the ablation threshold of the target material. Each pulse from laser 101 ablates material from the target area. The ablated material detaches from workpiece 106 as particles of ejecta 107, vapor, or both.

Management of ejecta in top-surface ablation systems can be critical to both workpiece quality and tool function. Ejecta redeposited on the workpiece can obscure details of the ablated pattern, detracting from its intended function. If the ablated surface is subsequently coated, redeposited ejecta can distort the coating profile. If the ejecta particles later lose adhesion to the workpiece surface, they can detach, leaving coating defects that degrade device performance or expose the device to damage that shortens its useful life. In addition, ejecta that adhere to processing optics absorb laser energy, decreasing the efficiency of the process and creating “hot spots” that can damage the condenser assembly elements. Known ejecta-management solutions include (1) gas blowers or vacuum lines to remove the ejecta as ablation occurs, (2) cleaning ejecta from workpieces by various methods after ablation is finished, (3) installing beam shields to keep ejecta from reaching the condenser optics (hollow, tapered shield designs are sometimes called “nozzles”), and (4) expanding the laser beam before condensing it, enabling the condenser working distance to be further from the target than the ejecta travel.

Bottom-surface ablation, as shown in conceptual diagram FIG. 1b, is a configuration that avoids many of the ejecta problems associated with top-surface ablation. Laser 101 produces beam 102, which is aimed by beam-steering assembly 103 and shaped into working spot 105 by condenser assembly 104. Here, however, working beam 102 travels through substrate 108 to ablate a target location on layer 106, which is on the bottom of substrate 105. Target layer 106 may be a coating or a treated layer of bulk material. Ejecta 107 naturally fall away from the workpiece and condenser assembly under gravity instead of being redeposited. Condenser assembly 104 is further shielded from flying ejecta by the interposition of substrate 108.

Bottom-surface ablation is only feasible in certain circumstances. First, the substrate and any “intervening” layers between the substrate and the target layer must (1) transmit sufficient energy from the working beam, with sufficient optical quality, to satisfactorily ablate the target layer, and (2) not be adversely affected by having the working beam pass through it. Second, the condenser's working distance must be long enough to include the optical path length through the substrate and intervening layers, with enough extra air space to maneuver the workpiece to the various target positions. Third, just as with top-surface ablation, the target layer must strongly absorb the working beam.

Each combination of laser wavelength, laser pulse duration, laser pulse shape, and target material has a minimum peak-power density (PPDₘᵢₙ) (peak power per unit area) that is an ablation threshold below which the target will not be ablated. In addition, each combination may also have a “collateral-damage threshold”: a maximum PPD (PPDₘₐₓ) beyond which undesirable side effects occur, such as distortion of the ablation profile, or melting or ablation of adjacent or non-target materials. PPDₘᵢₙ is usually a function of the target material physics, whereas PPDₘₐₓ is highly application-specific and dictated by design and process tolerances. A successful ablation process will have some working tolerance between PPDₘᵢₙ and PPDₘₐₓ.

In many ablation systems, the numerical aperture (NA), the sine of the convergence half-angle, is chosen to optimize the working spot diameter and the ablation depth of field (ADF). Focusing a given laser with a larger NA generally reduces the focused waist size, providing a smaller working spot for ablating fine-structured patterns. High-NA beams also diverge rapidly after focusing; for example, a single-mode Gaussian with a wavelength of 1064 nm and an 8 μm focused spot diameter doubles its spot diameter, reducing its PPD by 75%, 47 μm away from the focus position. If the PPD at the focused waist is set to PPDₘᵢₙ or slightly above, a high-NA working beam will have a shorter ADF than a low-NA working beam. Shortening the ADF to a length on the order of the target-layer thickness can help ensure PPD≧PPDₘᵢₙ at the target and ≦PPDₘₐₓ in non-target areas when fragile non-target areas include layers above and below the target layer.

FIG. 2 illustrates this principle: Suppose laser beams 201 and 202 have the same wavelength, the same peak pulse power, and the same mode structure and intensity profile. Beam 201 is focused at shallow convergence angle NA₀₁, while beam 202 is focused at steep convergence angle NA₀₂. Beam 202 produces a minimum spot diameter S₀₂, smaller than the corresponding S₀₁ for beam 201. Both beams cross the target ablation threshold at spot diameter Sₜₕ, so that beam 201 can ablate targets in any position within range ADF₀₁ and beam 202 can ablate targets in any position within range ADF₀₂. Near S02, though, beam 202 closely approaches PPDₘₐₓ and may damage non-target materials in that position. If the total power in beam 202 is reduced, the risk of damage will be mitigated, but ADF₀₂ will become even shorter.

One practice is to adjust the peak pulse power so that Sₜₕ ablates the maximum-width, minimum-depth recess within the design tolerance, and S₀ ablates the minimum-width, maximum-depth recess. These tolerances can be very small, with the corresponding ADF very short. If all the target areas on a workpiece are to be ablated in a single continuous operation without any focus adjustment, the optical path length (OPL) from the condenser to the target plane cannot vary more than ±ADF/2.

In top-surface ablation, OPL variations result from workpiece surface contours or slopes; from thermal expansion effects in the workpiece, its holder, the laser support framework, and the laser optics; and from non-parallelism in the mechanics that position the beam relative to the workpiece. In bottom-surface ablation, OPL variations result from all the same factors plus contours and thickness variations in all the workpiece surfaces above the target and refractive-index variations in the workpiece layers above the target. The cost of tightly controlling all these factors increases with workpiece size; for a large workpiece, this can become prohibitively expensive or even technologically unfeasible. Large sheets of tempered glass or optical polymer, such as those used in solar photovoltaic panels, large displays, and architectural or vehicle “smart windows,” are examples of large-area substrates that are difficult to laser-process with high precision because of observed variations in flatness, thickness, parallelism, and refractive index from batch to batch, piece to piece, and region to region on a single piece.

Where workpiece and tooling tolerances demand a long ADF but a larger spot-size is tolerable (that is, where product quality is insensitive to the increased size of the ablated features and the accompanying reduction in the remaining functional areas between ablations), some prior-art systems use the lowest feasible NA to get the longest possible ADF. This is expensive because more total laser power is required to achieve PPDₘᵢₙ in a larger spot, and higher-power lasers are generally more expensive because of the larger volume of active medium, more powerful pump mechanisms, cooling demands, etc. If the additional required power results in a higher safety classification for the laser, such as Class IV instead of Class III, the extra required safety measures also add to the cost of production. By contrast, small spot size delivers high PPD from a lower-power laser, and also leaves more functional area between ablations on the workpiece, facilitating smaller device size and higher yield per substrate.

Autofocus systems are a known alternative to requiring that workpiece surfaces be perfectly flat and perfectly parallel (and, in bottom-surface ablation, that the refractive indices of the substrate and intervening layers are perfectly uniform). An autofocus system is a closed-loop control system, active during an optical processing or imaging operation. FIG. 3 is a generic autofocus control diagram. When the autofocus system senses an error between the measured focus and a known in-focus reading, it commands a focus actuator to move either the workpiece or a condenser component substantially along the working-beam axis to drive the error to zero.

Many autofocus systems for other applications measure the focus condition of the actual working beam or illumination light. This is a difficult approach to apply to ablation lasers because ablation lasers generally deliver short, high-power pulses that can require expensive, specialized detection systems. Some prior-art autofocus systems for ablation lasers used broadband 2-D imaging, which required expensive achromatic optics and CCD cameras, as well as lamps whose waste heat needed careful management. A simpler approach is for the autofocus to sense the characteristics of a separate, low-power, continuous-wave beam with its focus aligned to the plane of the working spot. Diode lasers, small gas lasers, and even incoherent light sources such as LEDs may generate autofocus beams.

Many of the prior-art autofocus systems using this approach send the autofocus beam through a different optical train than the working beam. For example, in “Process optimization controller for robotic laser machining,” Abdullah et al. route the autofocus beam through a module beside the condenser. In U.S. Pat. No. 6,612,060, Nantel and Grozdanovski use a different beam path for their autofocus beam so that it (1) forms a line rather than a spot, and (2) strikes the workpiece at an oblique angle. In some of these systems, the autofocus also measures the distance to a point on the workpiece far removed from the ablation target. High-NA laser-ablation condensers are often highly temperature-sensitive; their working distances can change on the order of the ADF in factory environments where temperatures are not tightly controlled. Therefore, routing the autofocus beam through different optics than the working beam creates a risk that the autofocus will not track the working-beam focus changes with temperature and other mechanical effects.

Some prior-art autofocus systems gather all the autofocus data from a workpiece before beginning to process it. In U.S. Pat. No. 6,649,029, Fujimoto scans the entire surface of a semiconductor wafer and stores the data before processing begins, then retrieves the stored data for each target point just in time to process that point. Semiconductor wafers are rarely larger than 200 mm in diameter, and their processing usually takes place in a chamber whose temperature is well-regulated, so the data files are of a manageable size and the data is unlikely to change significantly during processing. A larger workpiece, such as a solar panel or display screen exceeding 0.5 m in size, would take much longer to scan and the data would take up much more storage space. In addition, the larger size would mean a longer time would elapse between the measurement and the processing of each target. These large workpieces are also generally processed in open factory environments where the temperature is not tightly controlled, so that local and ambient temperature drifts between measurement and processing can change the target positions significantly. Even larger inaccuracies can occur if the autofocus relies on stored data from earlier processes, such as Heyerick and Ulrich's U.S. Pat. App. No. 2002/0017152, which adjusts focus based on stored CNC data from when the workpieces were fabricated. Pre-process focus mapping, when not done simultaneously with another process as in '152, also significantly adds to process time, and therefore to overhead costs.

Few prior-art references mention the importance of bandwidth in autofocus systems for laser processing. Rapid processing of workpieces reduces the overhead-related cost of production. Meanwhile, the spatial frequencies of workpiece features that require focus adjustments can be high (e.g., surface microstructures from previous processes, or coating bumps and dips over buried features) as well as low (e.g., wedge, gradual surface contours, or gradual refractive-index changes in intervening layers). The bandwidth of an autofocus system must therefore exceed the product of the highest relative workpiece/working-spot velocity and the highest spatial frequency of features that could require a focus adjustment.

Abdullah et al., one of the few prior-art publications to deal with autofocus bandwidth, only mentions detector response time as a limiting factor. However, there are other limiting factors that must be considered, such as control-mechanism speed and autofocus spot size. For instance, the line-shaped focus of the autofocus beam in the '060 patent keeps the autofocus beam from disappearing into previously cut holes and slots in the workpiece, but it also may average out surface variations that fall within its length. Cutting lasers like that described in '060 can sometimes tolerate that averaging, but high-precision ablation lasers often cannot.

Therefore, ablation systems for large workpieces in open factory environments need an autofocus scheme that can track focus changes arising from thermal drifts affecting the workpiece or the working-beam condenser optics, as well as those from typical workpiece flatness, parallelism, thickness, and refractive-index tolerances. In addition, such autofocus schemes should operate at a bandwidth that will accurately read and compensate for both low- and high-spatial-frequency focus changes at high process speed.

### BRIEF SUMMARY OF THE INVENTION

An object of this invention is laser ablation at high pulse power with a working spot whose diameter is small and tightly controlled. Accordingly, this invention integrates an autofocus system using a separate beam to control the OPL between the condenser and the ablation target.

Another object of this invention is top-surface or bottom-surface laser ablation of thin films without affecting non-target material. Accordingly, the invention includes a condenser system producing a high numerical aperture, where the autofocus controls the spot diameter at the target and optionally also the peak pulse power in the working beam. This ensures that the working beam only exceeds the local ablation threshold at the target location.

Another object of this invention is high-accuracy laser ablation in a factory environment where temperature is not tightly controlled. Accordingly, this invention includes “on-the-fly” autofocus measurement very close in time to processing of each target, and an autofocus beam path that shares condenser optics with the working beam so that thermal effects affecting the working beam are detected and corrected by the autofocus.

Another object of this invention is high-speed processing of large workpieces. Accordingly, this invention includes an autofocus system with sufficient bandwidth to detect and compensate both gradual and rapid focus-error variations quickly and accurately.

### BRIEF DESCRIPTION OF THE DRAWINGS

FIG. 1a is a conceptual diagram of top-surface laser ablation.

FIG. 1b is a conceptual diagram of bottom-surface laser ablation.

FIG. 2 is an illustration of the effect of NA on spot-size and ADF.

FIG. 3 is a diagram of a generic autofocus control loop.

FIG. 4a is a schematic optical layout of a bottom-layer photoablation system according to the preferred embodiment.

FIG. 4b is a close-up of the working beam and autofocus beam impinging on a workpiece in the preferred embodiment.

FIG. 4c is an autofocus control loop in the preferred embodiment of the invention.

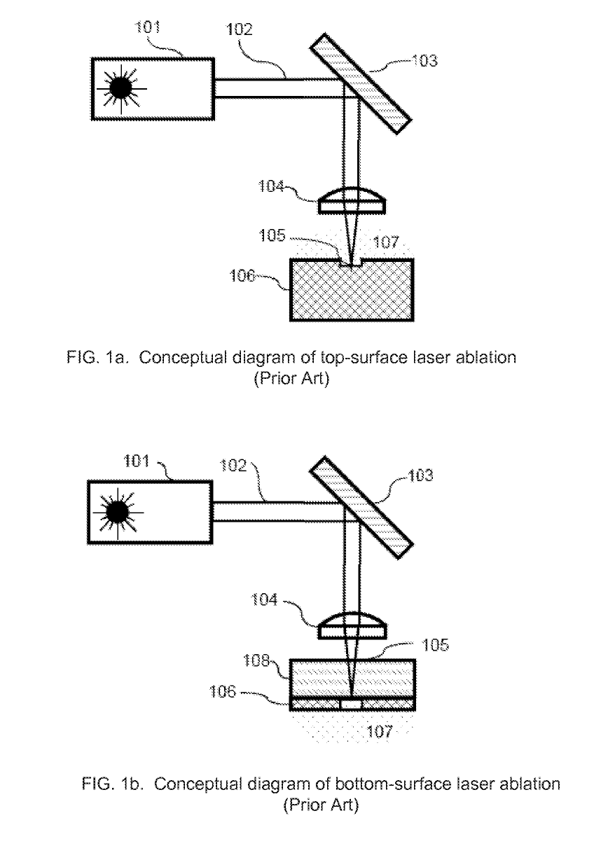

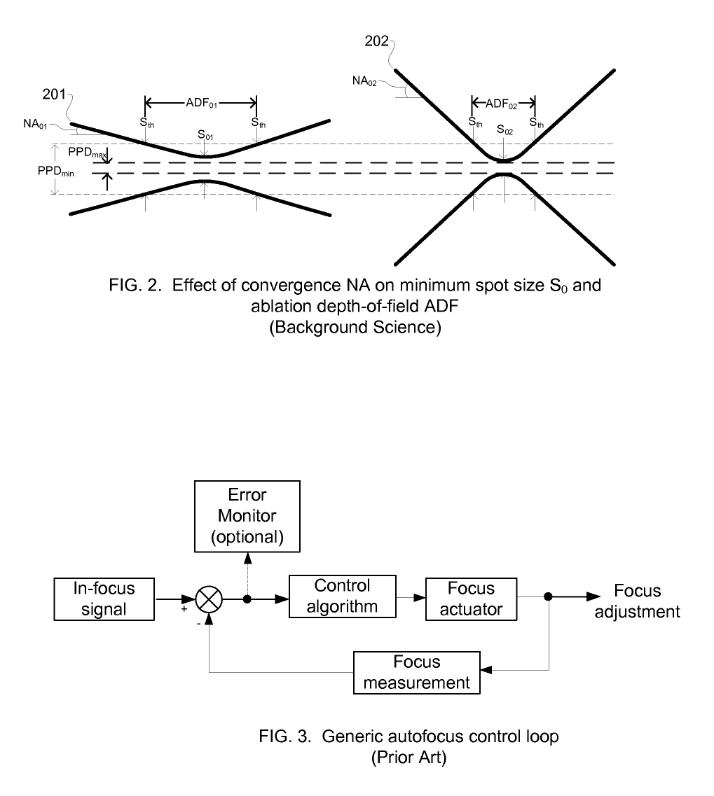

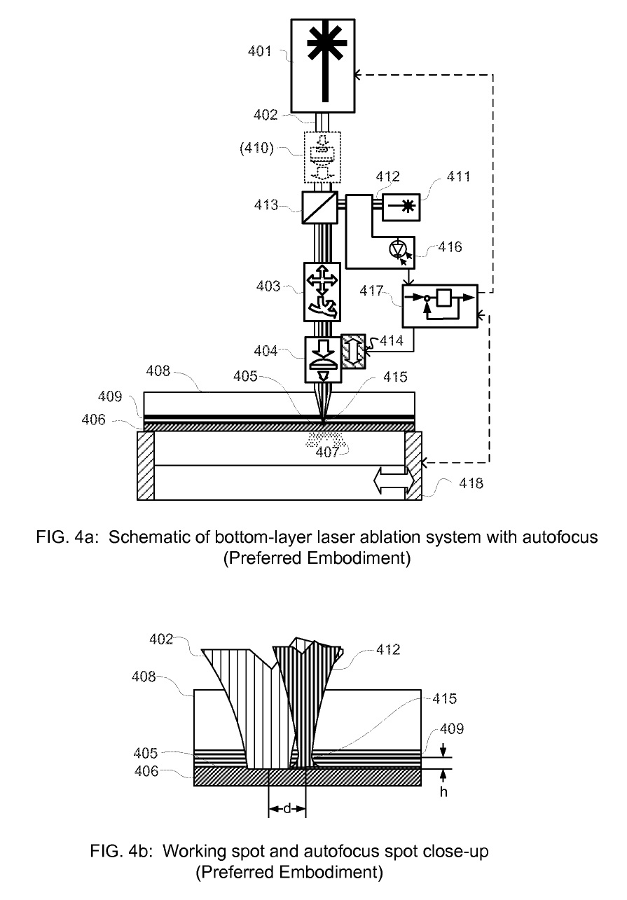

### DETAILED DESCRIPTION OF THE INVENTION

This invention is an autofocus subsystem optimized to meet the particular constraints of high-precision ablation. It co-propagates the autofocus and working beams through most of the beam train to ensure that the autofocus will be affected by the same thermal changes as the working beam. It increases the response bandwidth of the autofocus system to detect and correct “on the fly” as the working beam moves across the workpiece.

Temperature variations are a common source of focus error in applications such as ablation of large-area substrates, where the demand for precision is high and the temperatures of the workpiece and the ambient surroundings are not tightly controlled. The focus of the working beam is affected by thermally-induced variations in the optical properties of every optical element between the laser and the target (including non-target layers of the workpiece). For reflective surfaces, the thermally variable properties are mainly position and shape; for refractive objects, refractive index is also thermally variable. Because all these variations affect the working beam's focus, the autofocus should track them.

One approach to autofocus correction of temperature-based focus error is to have both beams (1) traverse the same path and (2) have substantially the same wavelength. These two measures ensure that temperature changes affect the working beam and the autofocus beam equally. However, making the autofocus wavelength different from that of the working beam has some counter-advantages. One is that the autofocus signal is stronger if the autofocus wavelength is substantially reflected by the ablation targets, but ablation is more efficient if the working wavelength is substantially absorbed by the targets; therefore the autofocus signal is more easily detectable if the autofocus beam has a different wavelength. The use of a commonly-available wavelength-selective (dichroic) reflector to combine the working and autofocus beams can also be convenient, but also requires that the working and autofocus wavelengths be different. In addition, if the working beam is ultraviolet or infrared, an autofocus beam with a visible wavelength may be advantageous both for human diagnostics of alignment and for use of a lower-cost focus detector. However, these advantages need not be sacrificed to gain accuracy in a temperature-varying environment as long as (1) a temperature change that would drive the working spot outside the focus tolerance would be detectable by the autofocus, and (2) conversion factors are built into the control algorithm to translate the measured error into the working-beam focus error. A different wavelength may be used for the autofocus detector as long as it is temperature-sensitive enough to measure and substantially shares the temperature-varying path traversed by the working beam.

Another way to prevent temperature drifts from degrading the accuracy of autofocus measurements is to measure immediately before ablating (at least within 1 second), rather than using stored measurements made minutes to days earlier. In the preferred embodiment, the autofocus measures “on the fly” as the ablation takes place.

The bandwidth of an autofocus system is critical to accurate processing speed, which in turn affects production cost. The required autofocus bandwidth is dictated by (1) the spatial frequency of features on the workpiece that could cause a focus error, and (2) the desired processing speed. The autofocus spatial resolution, which depends on its set-point spot size, should be sufficient to detect the highest-spatial-frequency features on the workpiece expected to contribute to focus error. The photocell(s) in the autofocus detection system and their pre-amplifiers and amplifiers should have a sufficiently short response time to detect focus errors as the high-spatial-frequency features pass under the autofocus beam at the desired processing speed. The autofocus controller should analyze the detector measurements quickly enough to send a correction signal to the autofocus actuator before an out-of-tolerance ablation occurs. The focus actuator should respond quickly enough, and its mechanical vibrations while moving and after stopping should be sufficiently damped, so that neither the autofocus set-point spot nor the working spot are blurred at the target. To enable the autofocus actuator to move both rapidly and accurately, the components it moves should be preferably have low mass; this suggests that, when ablating massive large-area workpieces, the autofocus actuator should preferably move some portion of the condenser assembly rather than the workpiece. Bandwidths of 10-100 kHz can significantly reduce production costs for large workpieces.

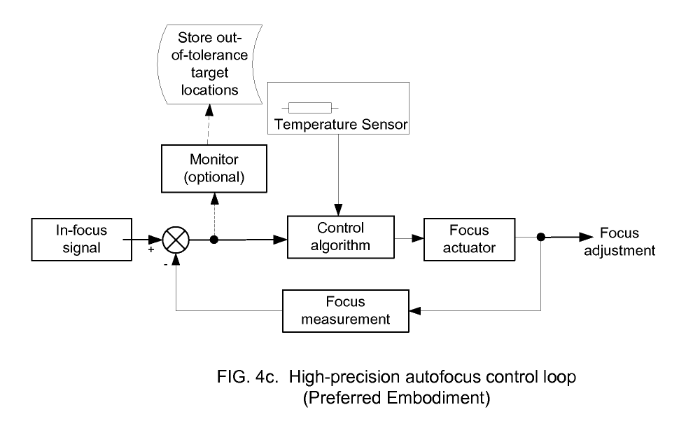

FIG. 4a is a schematic optical layout of a bottom-layer ablation system in a preferred embodiment of the invention. The workpiece, comprising substrate 408, target layer 406, and intervening layers 409, is supported by stage 418. Working laser 401 produces working beam 402. Optionally, beam expander (410) may expand working beam 402 to a larger diameter, so that it can be converged with a high NA at a sufficiently long working distance to accommodate the thickness of substrate 408, intervening layers 409, and a reasonable empty maneuvering space between the tool head and workpiece. Autofocus light source 411 produces autofocus beam 412, which is combined with working beam 402 by beam combiner 413. Beam combiner 413 is positioned substantially close to working laser 401 so that autofocus beam 412 shares most of working beam 402's optical path. Working beam 402 and autofocus beam 412 are then jointly adjusted in position and angle by beam steering assembly 403. Condenser assembly 404 includes one or more beam-shaping elements that shape working beam 402 into working spot 405 at target layer 406, and simultaneously shapes autofocus beam 412 into autofocus spot 415 nearby.

Target layer 406 absorbs working beam 402 and is ablated, producing ejecta 407. Preferably, stage 418 has one or more recesses to allow ejecta 407 to fall away from the workpiece, leaving a clean ablation. Meanwhile, target layer 406 substantially retro-reflects autofocus beam 412 back through condenser assembly 404 and beam-steering assembly 403, to beam combiner 413 which now acts as a beam splitter to separate the reflected autofocus beam from the incoming working beam. Autofocus detection assembly 416 then diverts at least part of the reflected autofocus beam to a photodetector that measures the focus condition of the autofocus beam. The measurements from autofocus detection assembly 416 are routed to focus controller 417, which compares the measurement to a set point representing in-focus condition, calculates the error, and drives focus actuator 414 to correct the error. Optionally, focus controller 417 may also control the peak pulse power of working laser 401 to keep the PPD of working spot 405 above PPDₘᵢₙ and below PPDₘₐₓ. Optionally, focus controller 417 may also sense and control stage 418 to store any locations where the error was excessive and, if directed to, return to them and repair them.

Beam expander (410), if used, may be reflective or refractive, but preferably will form no internal focus spots that could damage components. Beam combiner 413 may split and combine beams either by wavelength (dichroic beamsplitter) or by polarization (polarizing beamsplitter). Beam steering assembly 403 may include mirrors, prisms, wedges, or tiltable translation windows. Condenser assembly 404 may form working beam 402 into a focused waist, an image of an aperture, or a composite overlay of multiple beam sections. Condenser assembly 404 may be reflective or refractive, but preferably will form no internal working-beam focus spots that could damage components. Focus actuator 414 moves at least part of condenser assembly 404 along the propagation axis of working beam 402. In the preferred embodiment, focus actuator 414 is a lightweight electromagnetic actuator with a magnetic coil in either its stator or rotor. Its rotor, suspended by a flexure or other linear bearing, holds at least one of the optics of condenser assembly 404 and moves it substantially along its optic axis, to which working beam 402 and autofocus beam 412 are aligned. Autofocus detector assembly 416 may separate out the retroreflected autofocus beam by polarization or by amplitude splitting, may exclude reflections from non-target surfaces of the workpiece by placement of apertures or position detection, and may measure the focus condition of autofocus spot 415 by intensity, position, beam profile, or wavefront measurement. In another embodiment, the actuator is a piezoelectric linear actuator.

FIG. 4b illustrates configuration of the working beam 402 and autofocus beam 412 in the preferred embodiment of the more demanding case of bottom-surface ablation. Working beam 402 is substantially transmitted by substrate 408 and intervening layers 409, but is preferably strongly absorbed by target layer 406. Autofocus beam 411 preferably is substantially transmitted by substrate 408 and intervening layers 409, but is strongly reflected by target layer 406. Autofocus spot 415 may be separated from working-beam waist 405 by a lateral distance d and an axial distance h.

When the ablation process produces smooth-surfaced features, the most accurate autofocus reading may result when d=0. However, if the ablated surface is rough, the autofocus beam may be scattered, making its signal at the detector assembly too weak to read. In that case, d may be set >0. In the preferred embodiment, autofocus spot 415 measures a position slightly ahead of working spot 405 when ablating a continuous line (sometimes called “scribing”), and d is preferably an integral number of ablation diameters. A simpler embodiment for higher speed places autofocus spot 415 next to working spot 405, but off the scribing line so that scribing may proceed in either of two opposing directions.

If the smallest possible working spot is desired, h=0; that is, working spot 405 and autofocus spot 415 are the same distance from the back surface of the condenser. However, h may be set >0 if a larger working spot is desired for some operations. Larger-than minimal working spots are available in two directions from the focused spot, but where damage to non-target areas is an issue, one direction is more desirable than the other. By including adjustable optics at the autofocus source, h may be adjusted so that the autofocus detector assembly detects an in-focus condition when the desired working spot impinges on the target. For top-surface ablation, the working-beam's minimum-diameter spot should be above the target to avoid damaging non-target layers below it, so h should be set <0. For bottom-surface ablation, the working-beam's minimum-diameter spot should be below the target to avoid damaging non-target layers above it, so h should be set >0. If the autofocus detection system is sufficiently sensitive to the out-of-focus direction, the same goal can be achieved by reprogramming the set point of the controller without making any optical adjustment.

FIG. 4c is a control loop for a preferred embodiment of a high-precision autofocus for laser ablation of large workpieces in an open factory environment. At least one temperature sensor monitors the temperature at the most sensitive point in the beam train. The control algorithm senses the temperature changes and calculates the thermal portion of the focus error, accounting for the fact that the autofocus beam passes twice through the affected transmissive optics and transmissive parts of the workpiece, and, if applicable, for the different wavelength of the autofocus beam. The control output combines this converted adjustment for the thermal effects with an undisturbed adjustment for focus errors from non-thermal effects (e.g., surface contours on the workpiece). Optionally, the error monitor may read and store stage positions where excessive errors occur. For expensive workpieces where scrap is costly, this enables the system to go back and repair skipped spots in the ablation.

For ablation processes that are less sensitive to working-spot size, another embodiment can omit the focus actuator and have the controller only change the peak pulse power of the laser in response to the autofocus measurement. The working spot, though it may vary in size, will always exceed PPDₘₐₓ.

This use of an autofocus mechanism is an improvement over the prior art for laser ablation of line and spot patterns, particularly for bottom-surface ablation of large workpieces with high-spatial-frequency variations in surface profile or refractive index, where the ablation takes place in an open factory environment where temperatures are not tightly controlled. A laser ablation system with autofocus according to an embodiment of this invention has successfully produced long, straight scribed lines in thin films on ½-meter tempered-glass substrates, which was previously too difficult and costly for routine mass production. The shared beam path enables autofocus measurements to account for temperature-related focus errors arising in the working-beam optics as well as in the workpiece. The autofocus spot diameter substantially equal to the working spot diameter equalizes the spatial-frequency sensitivity of the two beams. Optimization of the variety of factors affecting autofocus bandwidth enables high processing speed without compromising ablation quality. Separating the autofocus spot slightly from the working spot allows measurement and ablation to take place simultaneously, even if the ablation disrupts the autofocus reading. “On-the-fly” measurements, unlike scan-and-store measurements, are no more complex or expensive for large workpieces than for small ones. In addition, minimizing the time between measurement and ablation minimizes the possibility of a temperature drift rendering the measurement inaccurate.

Those skilled in the art will recognize that neither this description nor the accompanying drawings, but only the claims, limit this invention's scope.

1. A system for laser ablation of a workpiece, comprising:
a working laser that generates a working beam,
a beam-steering assembly including at least one beam-steering element that aims the working beam at the workpiece,
a condenser assembly including at least one beam-shaping element to shape the working beam into a working spot capable of ablating a target area of the workpiece,
a focus actuator capable of moving at least one of the beam-shaping elements of the condenser assembly substantially along its optic axis, and
an autofocus assembly comprising
an autofocus light source generating an autofocus beam,
a combiner to combine the autofocus beam with the working beam,
an autofocus detector assembly to receive the reflection of the autofocus beam from the workpiece and produce measurement data related to the focus condition of the autofocus beam at the target, and
a controller capable of
calculating a focus error by comparing the measurement data to a set point, and
commanding the focus actuator to move at least one beam-shaping element of the condenser assembly to minimize the error,
where
the autofocus assembly operates at a system bandwidth of at least 10 kHz.

2. The system of claim 1, further comprising a beam-expander assembly that expands the working beam to a larger diameter before the condenser assembly shapes it into a working spot.

3. The system of claim 1, where the autofocus laser generates a different wavelength than the working laser, and the combiner is a dichroic reflector that transmits one of the wavelengths and reflects the other.

4. The system of claim 1, where the combiner is a polarizing beam combiner that transmits one orthogonal polarization and reflects the other, and the autofocus beam is polarized orthogonally to the working beam.

5. The system of claim 1, where the autofocus measurement and correction for each target area takes place less than 1 second before ablation of the target area.

6. The system of claim 1, where the focus actuator is an electromagnetic actuator with a rotor:
that holds at least one beam-shaping element of the condenser assembly,
that is suspended by a linear bearing or a flexure, and
that can be controllably moved along a direction substantially parallel to the optic axis of the working beam.

7. The system of claim 1, where the focus actuator is a piezoelectric actuator.

8. The system of claim 1, where the workpiece comprises a plurality of layers.

9. The system of claim 8, where at least one of the layers is a target layer that substantially absorbs the working beam and substantially reflects the autofocus beam.

10. The system of claim 9, where the target layer is the closest layer to the condenser during the ablation operation.

11. The system of claim 9, where the working beam and the autofocus beam are substantially transmitted through one or more transmissive non-target layers before reaching the target layer.

12. The system of claim 11, where at least one of the transmissive non-target layers is tempered glass or an optical polymer.

13. The system of claim 12, where the ablation produces a pattern comprising substantially straight lines at least 250 mm long.

14. The system of claim 1, where the autofocus beam travels through the same condenser assembly as the working beam.

15. The system of claim 14, where the autofocus beam travels through the same beam-steering assembly as the working beam.

16. The system of claim 15, further comprising a beam-expander assembly, through which the autofocus beam and the working beam both travel.

17. The system of claim 15, where the working spot and the autofocus spot are substantially concentric.

18. The system of claim 15, where the center-to-center spacing between the working spot and the autofocus spot is an integral number of working-spot diameters.

19. A method of ablating a pattern on a workpiece with a working laser, comprising:
arranging an autofocus spot from an autofocus light source to impinge on the workpiece near a working spot formed by the working beam generated by the working laser,
measuring the focus condition of the autofocus spot,
subtracting the measured focus condition from a set-point to calculate a total focus error,
measuring the temperature at a location where temperature changes affect the focus condition of the working spot,
calculating the amount of error attributable to thermal effects based on stored data about the optics and workpiece materials through which the autofocus beam travels twice,
subtracting the amount of error attributable to thermal effects from the total focus error to calculate a non-thermal focus error,
converting the amount of error attributable to thermal effects to a corrected thermal focus error for the working beam traveling through the optics and workpiece materials once, and
moving the focus actuator to compensate the sum of the corrected thermal focus error and the non-thermal focus error.
